(19) United States
(12) Patent Application Publication
(10) Pub. No.: US 2010/0166633 A1
(43) Pub. Date: Jul. 1, 2010

(54) CATALYST AND METHOD FOR DECOMPOSING VOLATILE ORGANIC COMPOUNDS

(75) Inventors: Hsin-Hsien Wu, Hsinchu County (TW); Kan-Sen Chou, Hsinchu City (TW); Hsien-Chang Yang, Hsinchu County (TW); Chin-Chao Huang, Hsinchu County (TW); Shou-Nan Li, Hsinchu County (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/636,739

(22) Filed: Dec. 13, 2009

(30) Foreign Application Priority Data
Dec. 30, 2008 (TW) 097151372

(51) Int. Cl. B01D 53/72; B01J 21/08; B01J 23/50

(52) U.S. Cl. 423/245.3; 502/243; 502/241

(57) ABSTRACT

A catalyst for decomposing volatile organic compounds is provided. The catalyst includes a mesoporous material and silver carried by the mesoporous material. The invention also provides a method for decomposing volatile organic compounds. The method includes providing a gas containing volatile organic compounds and contacting the gas containing volatile organic compounds and the disclosed catalyst to decompose and oxidize the gas containing volatile organic compounds into carbon dioxide and water.

### CROSS REFERENCE TO RELATED APPLICATIONS

This Application claims priority of Taiwan Patent Application No. 097151372, filed on Dec. 30, 2008, the entirety of which is incorporated by reference herein.

### BACKGROUND OF THE INVENTION

1. Field of the Invention

The invention relates to a catalyst, and more particularly to a catalyst and a method for decomposing volatile organic compounds.

2. Description of the Related Art

Air pollution seriously damages human health and the environment. For reducing certain pollutants, the European Union sets objectives for 2020: SO₂ emissions will need to decrease by 82%, NOx emissions by 60%, volatile organic compounds (VOCs) by 51%, ammonia by 27%, and primary PM2.5 (particles emitted directly into the air) by 59% compared with the year 2000. In addition, for controlling the emission, the Taiwan EPA added the VOCs in the Stationary Source Air Pollution Control Fee Rates System in 2006, and planed to revise the fee rates of VOCs in 2010. As a result, the rates are based on cumulative emissions, and revise from 123NTD/kg to 25-30NTD/kg.

According to the 2003 statistics, volatile organic compounds (VOCs) emission rate is over 864,000 tons per year in Taiwan. Low-concentration VOCs contribute significantly in the total emission. Previous results show that the control of high volumetric flow rate, low-concentration VOCs by conventional thermal oxidation technique is a challenging task. High energy consumption and carbon dioxide emissions are generated during incineration due to use of fuel. Thus, some energy-saving designs have been developed to treat VOCs. For example, the use of a honeycomb zeolite concentrator and a thermal oxidizer (or a regenerative thermal oxidizer) is one of the most popular methods demonstrated to control VOCs emissions from waste gases in semiconductor manufacturing plants. However, energy is also required even using the regenerative thermal oxidizer. According to statistics, the energy used by the top ten semiconductor manufacturers in Taiwan is about 3.9 hundred million NT$ per year (based on 14.65 NT$/m³ nature gas, with 26,530,000 m³ nature gas consumption per year). Additionally, the emission of carbon dioxide thereof is about 55,700 ton per year. With energy-saving and global warming issues, an exhaust gas treatment technique with low energy costs and low carbon emissions is desirable.

Taiwan Pat. No. 1255324 discloses a system and method for treating VOCs exhaust gas, using a roller concentrator follow by a plasma torch to concentrated and thermally oxidized VOCs. Additionally, the plasma torch provides a heat source to desorb VOCs from concentrator and to preheat the concentrated VOCs to oxidation.

Taiwan Pat. No. M320434 discloses an exhaust gas purification method for treating VOCs with a concentrator follow by an advanced oxidation process. An advanced oxidation unit is disposed to oxidize concentrated VOCs produced from the concentrator.

However, a large number of energy consumption is required when using the plasma torch or advanced oxidation process, thus hindering decrease of operating costs by manufacturers.

Catalytic combustion is one of the most promising abatement technology for VOCs, due to its definitive character and save of energy. Catalysts used for the complete oxidation of VOCs fall broadly into two categories: supported noble metals, typically platinum or palladium, and oxides of the transition metals, mainly oxides of chromium, cobalt, copper, nickel and manganese. A great deal of effort and a resulting large body of patent and technical paper is directed toward VOCs abatement by low temperature catalytic oxidation.

U.S. Pat. No. 4,304,761 discloses a method of oxidizing methanol by passing the exhaust gases over a silver catalyst. The silver has a relatively low reaction temperature for a high percentage conversion of methanol to CO₂ while producing no significant amount of undesirable byproducts such as formaldehyde. However, both platinum and palladium have an affinity for producing aldehyde.

### BRIEF SUMMARY OF THE INVENTION

One embodiment of the invention provides a catalyst for decomposing VOCs comprising a mesoporous material and silver carried by the mesoporous material. The catalyst further comprises an oxide of transition metal carried by the mesoporous material.

One embodiment of the invention provides a method for decomposing VOCs comprising providing a gas containing VOCs and contacting the gas containing VOCs and the disclosed catalyst to decompose and oxidize the gas containing VOCs into carbon dioxide and water.

Silver is easily adsorbed oxygen species on the surface to form an oxidation catalyst. These species are physisorbed and chemisorbed molecular oxygen and dissociatively adsorbed atomic oxygen. It also should be noted that the oxides of transition metal, such as oxides of chromium, cobalt, cerium, nickel, iron, magnesium and manganese, showed catalytic activities and abilities to donate lattice oxygen to silver to completely oxidize the VOCs. According to the described chemical properties, the invention provides a catalyst comprising a mesoporous material carried with silver and oxides of transition metal capable of complete decomposition and oxidation of VOCs into carbon dioxide and water. Specifically, under the catalyst, oxidation is performed at low temperatures, effectively reducing energy consumption and carbon dioxide emissions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 is an XRD figure of silver and SBA-15 according to one embodiment of the invention.

FIG. 2 shows a removal efficiency of gaseous acetone by silver/ferric oxide/SBA-15 catalysts according to one embodiment of the invention.

FIG. 3 shows a removal efficiency of gaseous isopropanol by silver/cerium oxide/SBA-15 catalyst according to one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides a catalyst for decomposing volatile organic compounds comprising a mesoporous material and silver carried by the mesoporous material. The catalyst further comprises an oxide of transition metal carried by the mesoporous material.

The mesoporous material, with an average pore size of about 2-50 nm, may be silicon oxide, aluminum oxide or silicon aluminum oxide, for example, SBA-15, with a specific surface area of about 600-1,000 m²/g. The silver has a particle size of about 2-50 nm and a weight ratio of about 1-30 parts by weight, based on 100 parts by weight of the catalyst.

The oxide of transition metal may comprise chromium oxide, cobalt oxide, cerium oxide, nickel oxide, ferric oxide, magnesium oxide, manganese oxide or combinations thereof. The oxide of transition metal has an average particle size of about 2-50 nm. The oxide of transition metal has a weight ratio of about 1-30 parts by weight, based on 100 parts by weight of the catalyst. The silver and transition metal oxide nanoparticles are loaded within the surface and nanoscale channels of the mesoporous material.

The silver is carried on the mesoporous material by an impregnation, ion-exchange or deposition-precipitation processes, with a 100-800° C. thermal treatment for several hours.

The catalyst may further be supported by a monolithic carrier. The monolithic carrier may comprise aluminum oxide, silicon oxide, silicon aluminum oxide, metal or metal oxide.

One embodiment of the invention provides a method for decomposing VOCs, comprising the following steps. A gas containing VOCs is provided. The gas containing VOCs is then contacted with the disclosed catalyst to decompose and oxidize the gas containing VOCs into carbon dioxide and water.

The gas containing VOCs may be an exhaust gas emitted from an engine, a volatilized gas from organic solvent or contaminated air. The VOCs may be alkane, alkene, aromatic compounds, ketone, ester, alcohol, organic acid, amino compounds or a mixture thereof, for example, exhaust gases emitted from semiconductor and optoelectrical manufactures such as isopropanol (IPA), acetone, propylene glycol monomethyl ether (PGME) or propylene glycol monomethyl ether acetate (PGMEA).

The gas containing VOCs contacts with the catalyst at a temperature less than 300° C., for example 100-300° C. The gas containing VOCs contacts with the catalyst at a space velocity of about 3,000-200,000 hr⁻¹. The gas containing VOCs contacts with the monolithic carrier carried with the catalyst at a space velocity of about 1,000-20,000 hr⁻¹.

Silver is easily adsorbed oxygen species on the surface to form an oxidation catalyst. According to the described properties, the invention provides a catalyst comprising a mesoporous material carried with silver and oxides of transition metal capable of complete oxidation of VOCs into carbon dioxide and water. Specifically, under the catalyst, oxidation is performed at low temperatures, effectively reducing energy consumption and carbon dioxide emissions.

### Example 1

Preparation of the Catalyst of the Invention

First, a surfactant and metal precursors was added to form a mesoporous template. Next, a TEOS (as silicon source) was added and stirred to prepare a mesoporous silicon dioxide carried with silver and transition metal oxides.

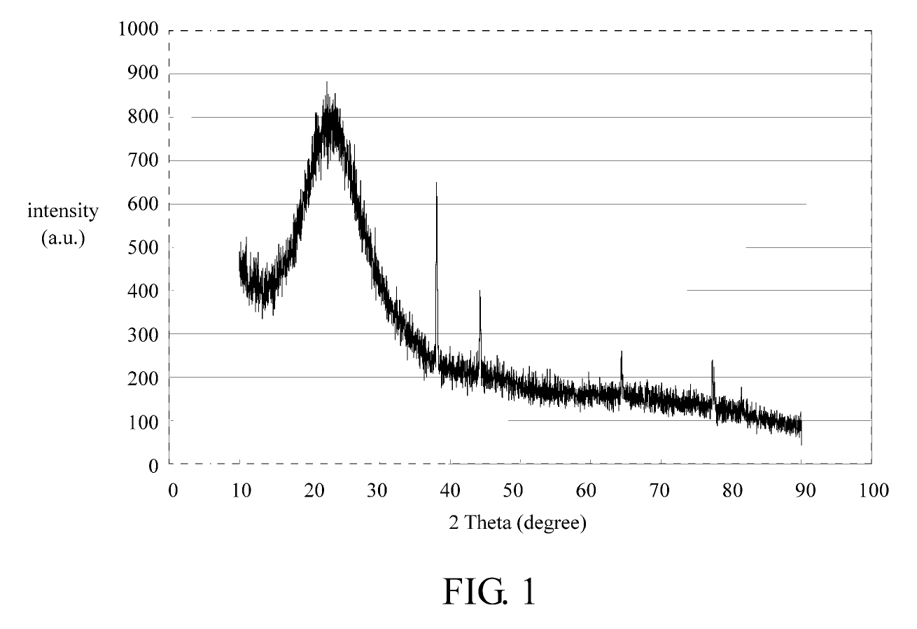

The XRD figure of the silver/SBA-15 catalyst calcined at 500° C. was as shown in FIG. 1. The results indicated that the catalyst comprises the silver and SBA-15.

### Example 2

Decomposition of Gas Containing VOCs

First, a 1,000 ppm gaseous acetone was provided. 0.1 g silver (10 wt %)/SBA-15 catalyst was then contacted with the gaseous acetone under 150-300° C. to decompose the gaseous acetone into carbon dioxide and water. The gaseous acetone was contacted with the silver/SBA-15 catalyst at a space velocity of 10,000 hr⁻¹.

The results indicated that the removal efficiency of the gaseous acetone reached 95% at a temperature of 250° C.

### Example 3

Preparation of the Catalyst of the Invention

Silver and ferric oxide were carried on the mesoporous SBA-15 with a deposition-precipitation method and a 300-800° C. thermal treatment to prepare a mesoporous silicon dioxide carried with silver and ferric oxide.

### Example 4

Decomposition of Gas Containing VOCs

First, a 500 ppm gaseous acetone was provided. 0.1 g silver/ferric oxide/SBA-15 catalyst was then contacted with the gaseous acetone under 150-300° C. to decompose the gaseous acetone into carbon dioxide and water. The gaseous acetone was contacted with the silver/ferric oxide/SBA-15 catalyst at a space velocity of 176,000 hr⁻¹.

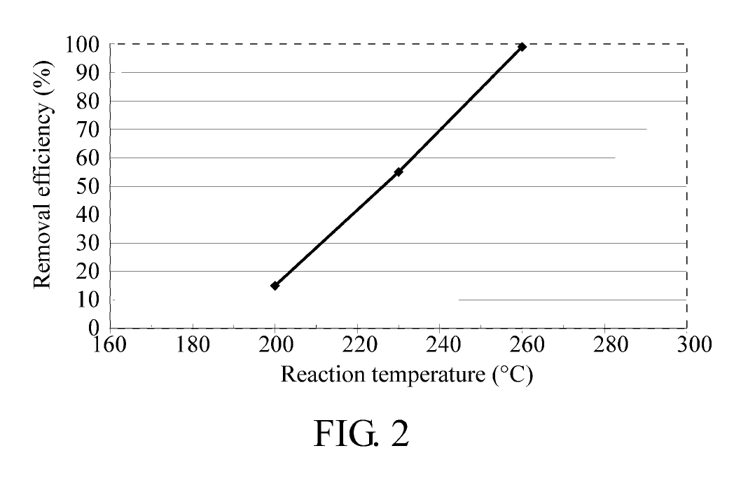

The results indicated that the removal efficiency of the gaseous acetone reached 99% at a temperature of 260° C., as shown in FIG. 2.

### Example 5

Preparation of the Catalyst of the Invention

Silver and cerium oxide were carried on the SBA-15 with a deposition-precipitation method and a 300-800° C. thermal treatment to prepare a mesoporous silicon dioxide carried with silver and cerium oxide.

### Example 6

Decomposition of Gas Containing VOCs

First, a 100 ppm gaseous isopropanol was provided. 0.1 g silver/cerium oxide/SBA-15 catalyst was then contacted with the gaseous isopropanol under 150-300° C. to decompose the gaseous isopropanol into carbon dioxide and water. The gaseous isopropanol was contacted with the silver/cerium oxide/SBA-15 catalyst at a space velocity of 176,000 hr⁻¹.

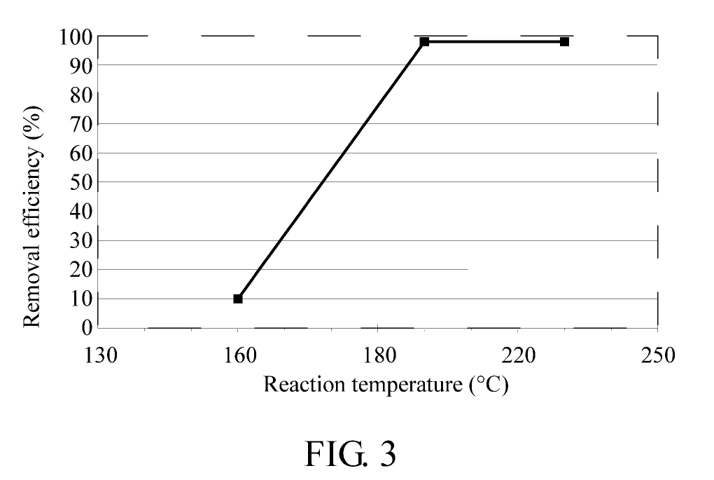

The results indicated that the removal efficiency of the gaseous isopropanol reached 99% at a temperature of 200° C., as shown in FIG. 3.

### Example 7

Preparation of the Catalyst Carried by a Monolithic Carrier of the Invention

Silver and cerium oxide, manganese oxide were carried on the SBA-15 with a deposition-precipitation method and a 300-800° C. thermal treatment. The catalyst was further carried by a monolithic ceramics (50 mm in diameter, 50 mm in height and 100 cell/in²). The catalyst has a weight ratio of 10 parts by weight, based on 100 parts by weight of the monolithic ceramics.

### Example 8

Decomposition of Gas Containing VOCs

First, a 140 ppm gaseous isopropanol was provided. The catalyst prepared by Example 7 was then contacted with the gaseous isopropanol under 100-300° C. to decompose the gaseous isopropanol into carbon dioxide and water. The gaseous isopropanol was contacted with the monolithic ceramics at a space velocity of 12,000 hr⁻¹.

The results indicated that the removal efficiency of the gaseous isopropanol reached 95% and 50% at a temperature of 200° C. and 150° C., respectively.

In addition, the removal efficiency of a 10 ppm gaseous PGME reached 50% at a temperature of 80° C., and the removal efficiency of a 120 ppm gaseous Acetone reached 95% and 50% at a temperature of 200° C. and 145° C., respectively.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A catalyst for decomposing volatile organic compounds, comprising:
a mesoporous material; and
silver carried by the mesoporous material.

2. The catalyst for decomposing volatile organic compounds as claimed in claim 1, wherein the mesoporous material is silicon oxide, aluminum oxide or silicon aluminum oxide.

3. The catalyst for decomposing volatile organic compounds as claimed in claim 1, wherein the mesoporous material has a pore size of 2-50 nm.

4. The catalyst for decomposing volatile organic compounds as claimed in claim 1, wherein the silver has a particle size of 2-50 nm.

5. The catalyst for decomposing volatile organic compounds as claimed in claim 1, wherein the silver has a weight ratio of 1-30 parts by weight, based on 100 parts by weight of the catalyst.

6. The catalyst for decomposing volatile organic compounds as claimed in claim 1, further comprising an oxide of transition metal carried by the mesoporous material.

7. The catalyst for decomposing volatile organic compounds as claimed in claim 6, wherein the oxide of transition metal comprises chromium oxide, cobalt oxide, cerium oxide, nickel oxide, ferric oxide, magnesium oxide, manganese oxide or combinations thereof.

8. The catalyst for decomposing volatile organic compounds as claimed in claim 1, wherein the catalyst is supported by a monolithic carrier.

9. A method for decomposing volatile organic compounds, comprising:
providing a gas containing volatile organic compounds; and
contacting the gas containing volatile organic compounds and a catalyst as claimed in claim 1 to decompose and oxidize the gas containing volatile organic compounds into carbon dioxide and water.

10. The method for decomposing volatile organic compounds as claimed in claim 9, wherein the gas containing volatile organic compounds is an exhaust gas emitted from an engine, a volatilized gas from organic solvent or contaminated air.

11. The method for decomposing volatile organic compounds as claimed in claim 9, wherein the volatile organic compounds are alkane, alkene, aromatic compounds, ketone, ester, alcohol, organic acid, amino compounds or a mixture thereof.

12. The method for decomposing volatile organic compounds as claimed in claim 9, wherein the volatile organic compounds are isopropanol (IPA), acetone, propylene glycol monomethyl ether (PGME) or propylene glycol monomethyl ether acetate (PGMEA).

13. The method for decomposing volatile organic compounds as claimed in claim 9, further comprising performing a thermal treatment on the catalyst.

14. The method for decomposing volatile organic compounds as claimed in claim 13, wherein the thermal treatment has a temperature of 100-800° C.

15. The method for decomposing volatile organic compounds as claimed in claim 9, wherein the gas containing volatile organic compounds contacts with the catalyst at a temperature less than 300° C.

16. The method for decomposing volatile organic compounds as claimed in claim 9, wherein the gas containing volatile organic compounds contacts with the catalyst at a temperature of 100-300° C.

17. The method for decomposing volatile organic compounds as claimed in claim 9, wherein the gas containing volatile organic compounds contacts with the catalyst at a space velocity of 3,000-200,000 hr⁻¹.

18. The method for decomposing volatile organic compounds as claimed in claim 9, further comprising carrying the catalyst by a monolithic carrier.

19. The method for decomposing volatile organic compounds as claimed in claim 18, wherein the gas containing volatile organic compounds contacts with the monolithic carrier at a space velocity of 1,000-20,000 hr⁻¹.
